(19) United States
(12) Patent Application Publication
(10) Pub. No.: US 2005/0157971 A1
(43) Pub. Date: Jul. 21, 2005

(54) Apparatus comprising an optical input device and at least one further optical device having a common radiation source

(76) Inventors: Rene Juijve, Eindhoven (NL); Fransiscus Gerardus Coenradus Verweg, Heerlen (NL)

Correspondence Address: PHILIPS INTELLECTUAL PROPERTY & STANDARDS, P.O. BOX 3001, BRIARCLIFF MANOR, NY, 10510, US

(21) Appl. No.: 10/514,290

(22) PCT Filed: May 13, 2003
(86) PCT No.: PCT/IB03/02007

(30) Foreign Application Priority Data
May 17, 2002 (EP) 02076932.9

(51) Int. Cl. G02B 6/00

(52) U.S. Cl. 385/12

(57) ABSTRACT

In an apparatus comprising an optical input device (220) controlled by a moving object and also comprising at least one further optical device (230,240) to be provided with electromagnetic radiation (225,226), wherein the input device comprises at least one diode laser (222) for supplying at least one measuring beam to a window (221) of the input device, the rear side of at least one of the ne diode lasers of the input device is optically coupled to at least one of the other optical devices so as to supply such a device with radiation. In this way, space and cost can be saved, which makes the apparatus very suitable for small and battery-powered mobile apparatus, like a mobile phone, a hand-held computer, a laptop computer, etc.

The invention relates to an apparatus comprising an optical input device controlled by a moving object and also comprising at least one further optical device to be supplied with electromagnetic radiation.

The moving object is, for example a human finger, but may also be any object that is suitable to be moved across a window of the input device.

The invention is especially intended for use in small hand-held apparatus, for example a mobile phone, a personal digital agenda, a hand-held computer. Such an apparatus comprises a flat display panel for displaying information either received from external sources or entered by the user or generated by a digital processor (internal microcomputer). The apparatus further comprises a keyboard for dial entry, i.e. choose a telephone number, and other functions, like activating software programs either stored in the digital processor or available from external sources to which the apparatus has access. The apparatus may further comprise an illumination device for illuminating the keyboard in case of poor daylight conditions. For scrolling software menus and selecting a special program of such a menu, the apparatus is provided with an input device controlled by a user's finger.

An input device for moving a cursor across a display panel and for clicking at a given position of the cursor, is conventionally formed by a pad integrated in, for example, the keyboard of a notebook. Such a pad requires a certain space and is less suitable for use in a hand-held apparatus. Optical input devices, which have been and are being developed, are much more suitable for such applications.

EP-A 0 942 285 describes such an optical input device, which can be characterized as an inverted optical mouse. The input device is stationary and, for example, built in the keyboard of a desk top or notebook computer or hand-held computer and controlled by moving a finger across a transparent window in the housing of the input device. This input device may be small, because the optical module for measuring the finger movement can be made small. In fact, the input device is reduced to the optical module. All of the several embodiments of the input device described in EP-A 0 942 285 use homodyne or heterodyne detection. In the optical module, a diffraction grating is arranged close to the module window. The grating reflects a portion of the measuring beam radiation supplied by a diode laser, to a detector, which also receives a portion of the radiation, which is reflected and scattered by the finger. The laser radiation reflected by the grating and captured by the detector is denoted as local oscillator beam. The detector coherently detects the radiation from the finger using this local oscillator beam. The interference of the radiation reflected by the finger and reaching the detector with the local oscillator beam gives rise to a beat signal from the detector, which signal is determined by the motion of the finger parallel to the window surface. The optical measuring module of EP-A 0 942 285 comprises, besides the diode laser and the grating, a collimator lens, a focusing lens and a pinhole diaphragm arranged before the detector, which element should be aligned very accurately.

A simpler optical input device, which comprises fewer elements and is easier to manufacture, is described in a previous patent application in the name of the present applicant. This input device uses the so-called self-mixing effect in a diode laser. This is the phenomenon that radiation emitted by the diode laser and re-entering the laser cavity induces a variation in the gain of the laser and thus in the radiation emitted by the laser. In this device, the window is illuminated by a skew laser beam, which has a component in the direction in which the finger is to be moved. If the finger is moved, the laser radiation scattered by the finger gets a frequency, which is different from the frequency of the radiation illuminating the window and the finger, because of the Doppler effect. A portion of the scattered radiation is focused on the diode laser by the same lens that focuses the illumination beam on the finger. Because some of the scattered radiation enters the laser cavity through the laser mirror interference of radiation takes place in the laser cavity. This gives rise to fundamental changes in the properties of the laser and the emitted radiation. Parameters, which change due to the self-mixing effect, are the power, the frequency and the line width of the laser radiation and the laser threshold gain. The result of the interference in the laser cavity is a fluctuation of the values of these parameters with a frequency that is equal to the difference between the frequency of the measuring beam and the frequency of the scattered radiation. This difference is equal to the velocity of the finger or, in general, an object that is moved relative to the device window. Thus, the velocity of the object and, by integration over time, the displacement of the object can be determined by measuring the value of one of said parameters. This measuring method can be carried out by means of only a few, simple components and does not require an accurate alignment of these components.

Each of the other devices of the type mentioned above requires electromagnetic radiation for its functioning and this radiation is conventionally supplied by a separate light-emitting diode (LED) or another light source for each device. Each light source is accommodated in its own housing so that, when a number of optical functions has to be integrated in an apparatus, the space occupied by the housings of the source becomes a problem, especially in a hand-held apparatus. Moreover, these sources have a low radiation efficiency so that they consume much electrical energy. As the energy in a hand-held apparatus is supplied by batteries, these batteries should be recharged rather frequently, which is annoying for the user. As a radiation source is a relatively expensive component, the use of a number of such components makes the total apparatus expensive.

It is an object of the present invention to provide an apparatus as described hereinbefore, wherein the means for generating radiation for the devices occupy only a small portion of the volume of the apparatus and wherein these means consume less electrical power. This apparatus is characterized in that the input device comprises at least one diode laser for supplying at least one measuring beam to a window of the input device, said measuring beam measuring movement of the object with respect to the window, and in that the rear side of at least one of the diode lasers of the input device is optically coupled to at least one of the other optical devices so as to supply such a device with radiation.

The rear side of a diode laser is understood to mean the radiation-emitting side of a diode laser opposite the side where the measuring beam is emitted.

The input device may be provided with more than one diode laser. In that case, more than one diode laser of the input device may also supply radiation to said other devices. Each diode laser of the input device may also supply radiation to a different one of the other devices, or all diode lasers of the input device may also supply radiation to all of the other devices. It is also possible that one diode laser of the input device also supplies one of the other devices, whilst each of the remaining diode lasers of the input device also supplies radiation to all of the remaining other devices.

The invention makes advantageous use of the fact that a diode laser emits light at two opposite sides, the front side and the rear side, of the laser crystal. In conventional applications of a diode laser, the front side is used as a light source and the rear side faces a radiation-sensitive detector, i.e. a monitor diode, which is usually used to control the intensity of the laser beam. In the apparatus of the present invention, the laser beam emitted at the front side of the diode laser is used as a measuring beam of the input device, whilst the laser beam emitted at the rear side of the diode laser is used as an illuminating beam for another device present in the apparatus. The radiation-sensitive detector, i.e. a photodiode, for measuring the intensity of the laser radiation and for determining the movement of the object relative to the window of the input device can be arranged at a location other than the usual one, either in the input device or in at least one of said other devices.

A first embodiment of the apparatus is characterized in that at least one of the diode laser of the input device is optically coupled to a light guide of an optical keyboard.

An optical keyboard is understood to mean a keyboard having movable keys (buttons) and a flat light guide arranged under the keyboard surface and provided with means to guide radiation along the positions of the keys and then to a radiation-sensitive detector. Each key has a portion which, upon pushing the key, moves into a radiation path within the light guide and changes the amount of radiation received by the detector via this light path. Such an optical keyboard is known per se, for example from EP-A 1 094 482, and relates to a portable communication apparatus having a display and an optical keyboard. The backlight of the display and the light guide are supplied with radiation from the same sources, i.e. a number of LEDs. The apparatus does not comprise an optical input device with one or more diode lasers.

A second embodiment of the apparatus is characterized in that at least one of the diode lasers of the input device is optically coupled to a lighting means for illuminating a flat display panel. The flat display panel may be any display panel that uses a backlight to uniformly illuminate the matrix of light valves, or pixels by means of which the displayed image is generated. Examples of such a display panel are liquid crystal panels or display panels based on electrophoresis or electroluminescence. The radiation from the diode laser can be directed via stationary means, like mirrors to the light guide. In case the input device and the display device are embedded in different portions of the apparatus, which are tiltable relative to each other, flexible means, like an optical fiber can be used to guide the radiation from the diode laser to the light guide.

A third embodiment of the apparatus is characterized in that at least one of the diode lasers of the input device is optically coupled to an illuminating device for illuminating a keyboard of the apparatus.

Such an illuminating device is known per se, interalia from U.S. Pat. No. 5,815,225, and relates to a laptop computer wherein light pipes are used to convey radiation from the liquid crystal display backlighting light source to the mechanical keyboard. This allows a good view on the keyboard and the surrounding work area in poor day or artificial light conditions.

A fourth embodiment of the apparatus is characterized in that at least one of the diode lasers of the input device is coupled to an optical microphone of the apparatus.

An optical microphone uses an optical beam and, for example, a position-sensitive detector for measuring the movement of the beam, which is reflected by the membrane of the microphone, which movement is caused by vibrations of the membrane. The measuring beam for this microphone can be supplied by a diode laser of the optical input device.

With respect to the optical input device, several main embodiments are possible.

A first of these embodiments is characterized in that the input device comprises a partially transmitting object arranged close to the window so as to split off a portion of the measuring beam, as a reference beam and radiation-sensitive detection means with a small opening so as to receive the reference beam and measuring beam radiation reflected by the object.

This optical input device is known per se from EP-A 0 942 285, and relates only to the input device, not to its integration in an apparatus comprising more optical devices. Most practically, the partially transmitting object is a diffraction grating and the small opening in the radiation-sensitive means is realized by means of a pinhole arranged in front of a photodiode.

A second and preferred main embodiment, wherein the optical input device comprises converting means for converting measuring beam radiation reflected by the object into an electric signal, is characterized in that the converting means are constituted by the combination of a laser cavity and measuring means for measuring changes in operation of the laser cavity, which changes are due to interference of reflected measuring beam radiation re-entering the laser cavity and the optical wave in this cavity and are representative of the movement of the object.

This optical input device of this main embodiment comprises fewer components and is easier to manufacture than that of the first main embodiment.

A first embodiment of the second main embodiment is characterized in that the measuring means are means for measuring a variation of the impedance of the laser cavity.

A preferred embodiment of the second main embodiment is characterized in that the measuring means is a radiation detector for measuring radiation emitted by the laser.

The radiation detector may be arranged in such a way that it receives part of the radiation of the measuring beam.

This embodiment of the input device is, however, preferably characterized in that the radiation detector is arranged at the side of the laser cavity where the measuring beam is emitted.

For example, such an intensity-measuring photodiode can be arranged between the diode laser and the lens of the input device either at a position where it receives radiation reflected by a component of the input device or at a position where it receives radiation split off from the measuring beam.

An apparatus having an input device for measuring a movement of an object and the device relative to each other in a plane parallel to the illuminated surface of the object, is characterized in that the optical input device comprises at least two diode lasers and at least one detector for measuring a relative movement of the object and the device along a first and a second measuring axis, which axes are parallel to the illuminated surface of the object.

As will be explained hereinafter, this device and other devices utilizing two or more measuring beams may be provided with a separate detector for each measuring beam. However, it is also possible to use one and the same detector for all measuring beams if time-sharing is used.

An apparatus having an input device which allows a third relative movement of the object and the device to be measured, is characterized in that the optical input device comprises three diode lasers and at least one detector for measuring a relative movement of the object and the device along a first, a second and a third measuring axis, the first and second axes being parallel to the illuminated surface of the object and the third axis being substantially perpendicular to this surface.

This embodiment of the input device recognizes a single movement of the object and the device along the third measuring axis and converts it into an electric signal by means of which a click action may be determined.

An apparatus having an optical input device which allows determination of both a scroll action and a click action is characterized in that the optical input device comprises two diode lasers and at least one detector for measuring relative movements of the object and the device along a first measuring axis parallel to the object surface and along a second measuring axis substantially perpendicular to the object surface.

The first measuring axis is used to determine a scroll action and the second measuring axis is used to determine a click action.

Alternatively, this apparatus may be characterized in that the optical input device comprises two diode lasers and at least one detector for measuring relative movements of the object and the device along a first and a second measuring axis, which axes are at opposite angles with respect to a normal to the object surface.

The signals from both measuring axes comprise information about the scroll action and the click action, and the specific scroll action information, as well as the specific click action information, can be isolated by appropriately combining the information of the two measuring axes.

The new apparatus may be used in different applications, such as in a mobile phone, a cordless phone, a laptop computer or a hand-held computer.

These and other aspects of the invention are apparent from and will be elucidated, by way of non-limitative example, with reference to the embodiments described hereinafter.

In the drawings:

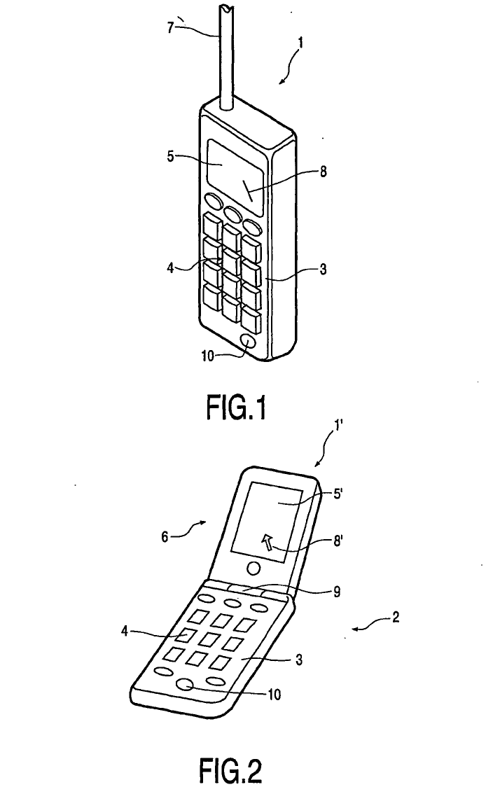

FIG. 1 shows a first embodiment of a mobile phone wherein the invention is incorporated;

FIG. 2 shows a second embodiment of such a mobile phone;

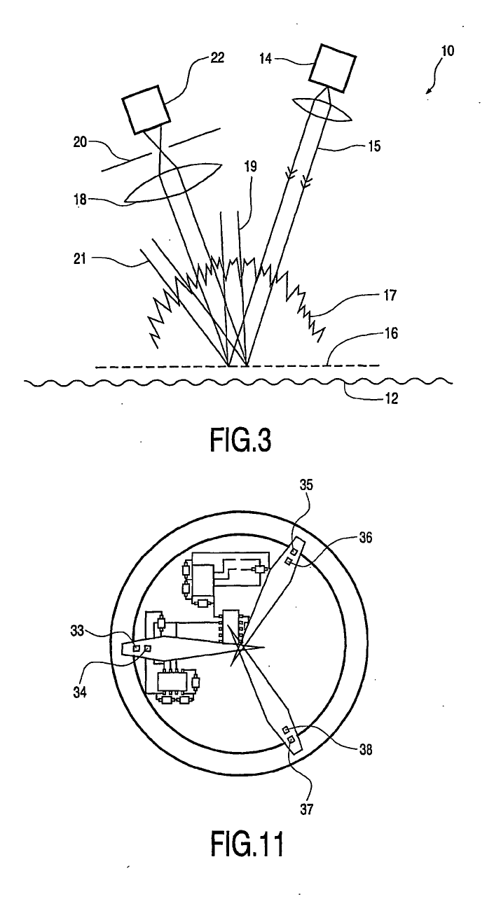

FIG. 3 shows a known optical input device;

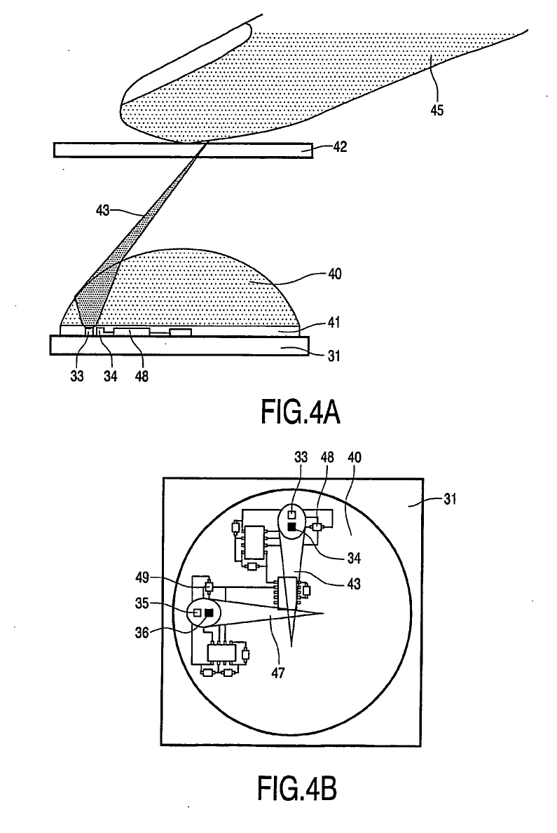

FIG. 4a shows, in a cross-section, an embodiment of a new optical input device;

FIG. 4b is a top view of this embodiment;

FIG. 5 shows the measuring principle of this input device;

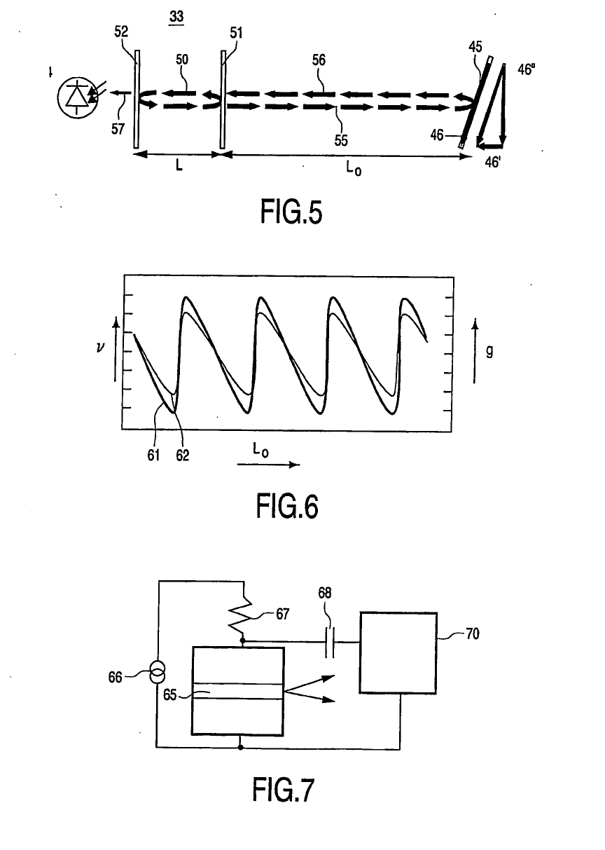

FIG. 6 shows the variation of the optical frequency and of the gain of the laser cavity as a function of the movement of the device and an object relative to each other;

FIG. 7 shows a method of measuring this variation;

FIG. 8 shows the variation of laser wavelength as a function of the temperature of the laser with optical feedback;

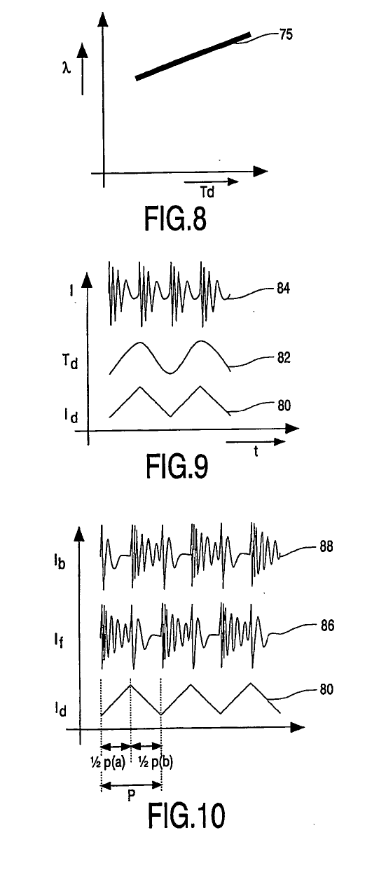

FIG. 9 shows the effect of using a periodically varying drive current for a laser;

FIG. 10 shows how the direction of movement is detected;

FIG. 11 shows a diagram of an optical input device with three measuring axes;

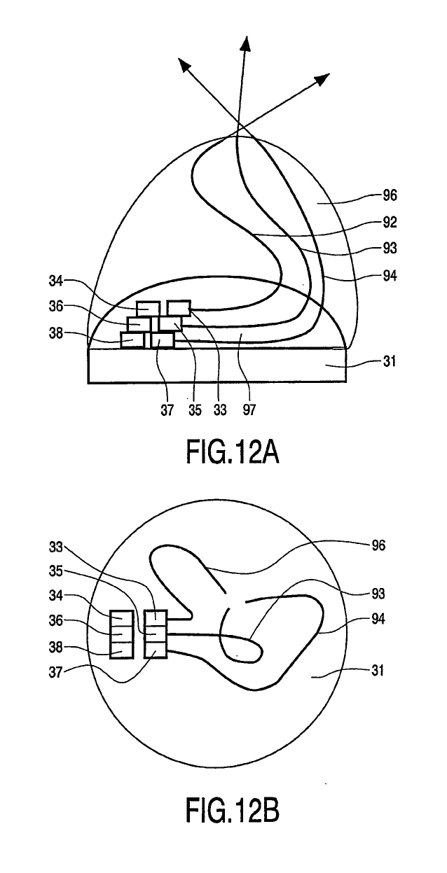

FIGS. 12a and 12b show an embodiment of the input device wherein fibers are used;

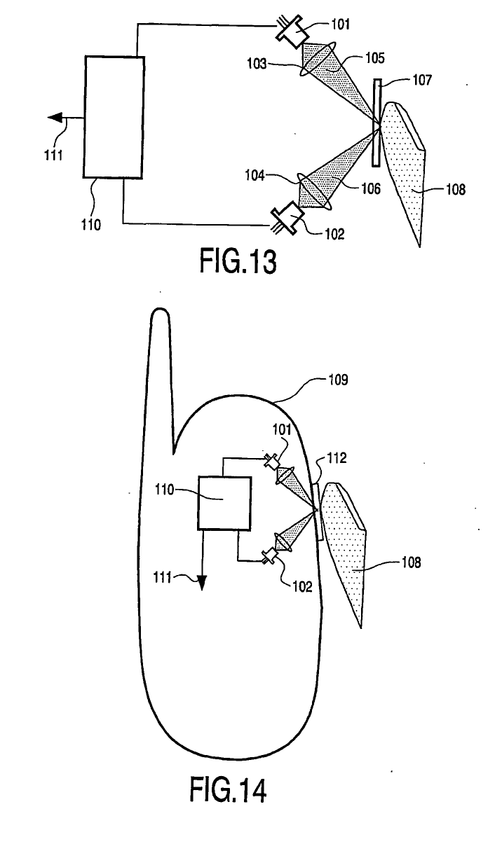

FIGS. 13 and 14 show a first embodiment of a scrolling and clicking input device;

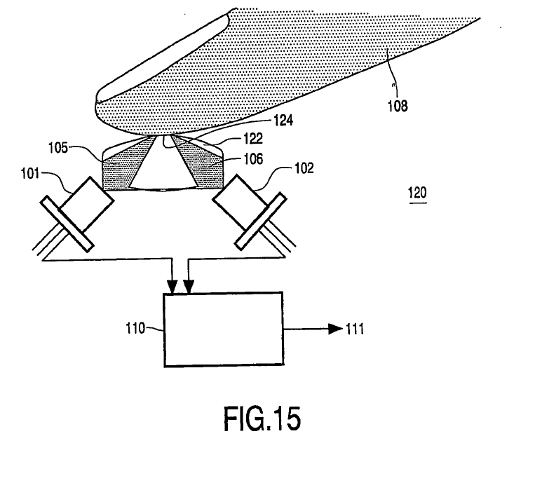

FIG. 15 shows a second embodiment of this device;

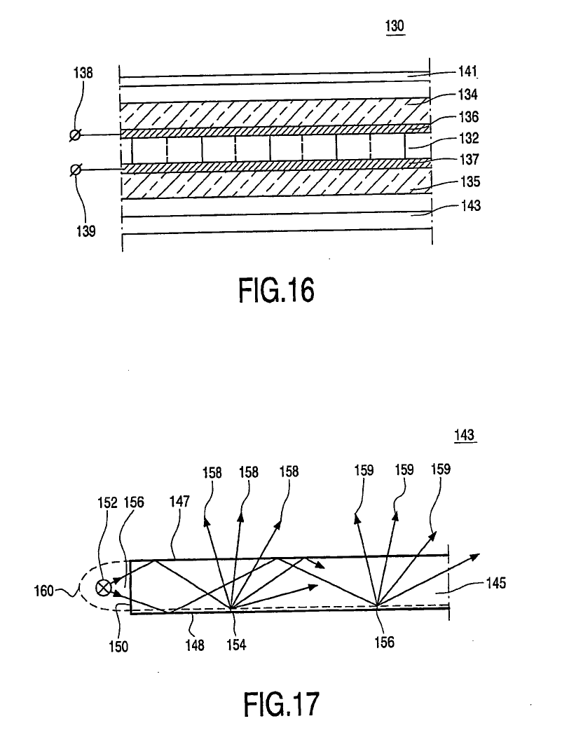

FIG. 16 is a diagram of a transmission LCD panel for use in an apparatus according to the invention;

FIG. 17 shows an embodiment of the lighting means to be used with such a panel;

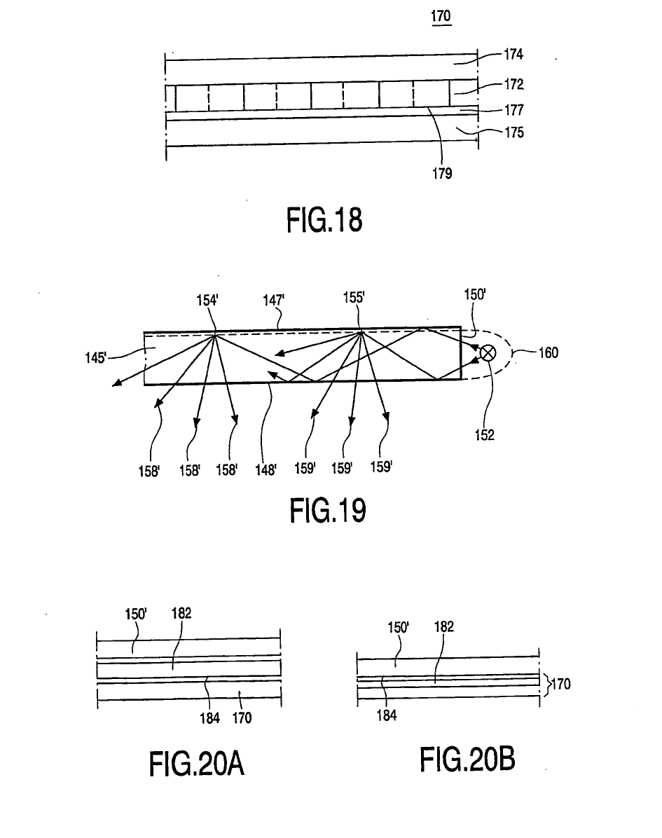

FIG. 18 is a diagram of a reflective LCD panel;

FIG. 19 shows an embodiment of the lighting means to be used with such a panel;

FIGS. 20a and 20b show two embodiments of an image-sensing display device for use in an apparatus according to the invention;

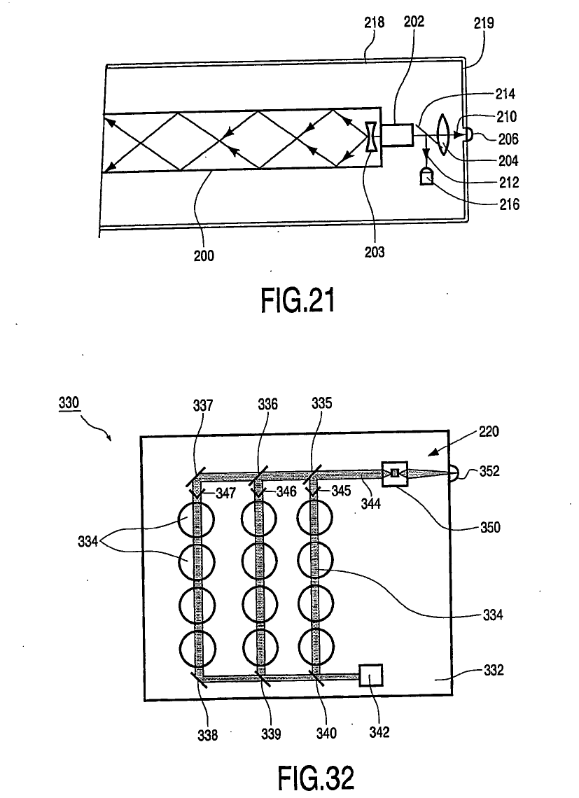

FIG. 21 shows how a lighting means for a display panel can be supplied with radiation from the optical input device;

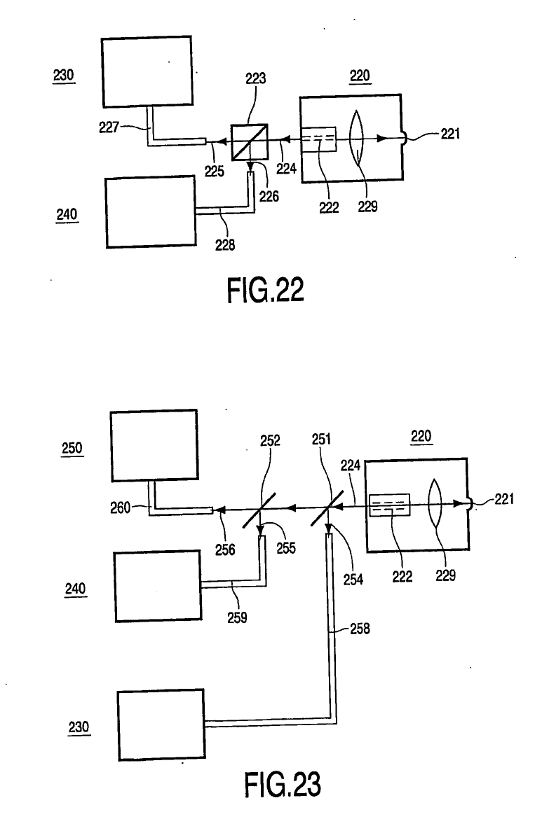

FIGS. 22 to 27 show examples of supplying a different number of other optical devices with radiation from optical input devices having a different number of diode lasers;

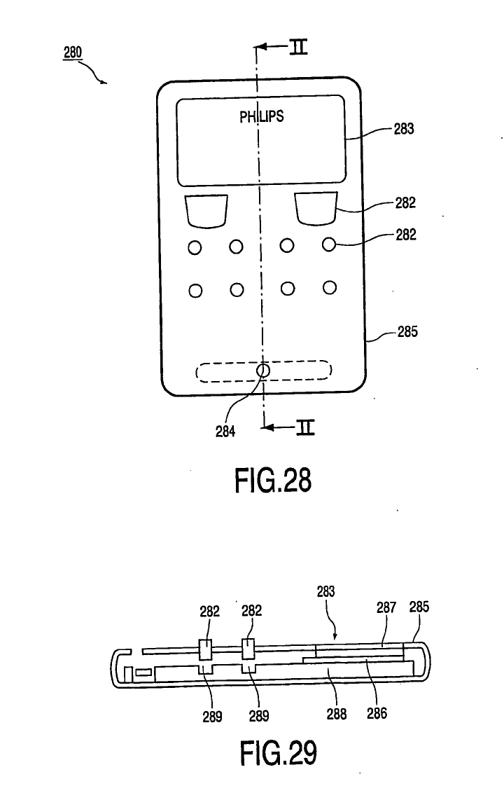

FIG. 28 is a top view of a mobile phone having an optical keyboard;

FIG. 29 is a cross-section of this mobile phone;

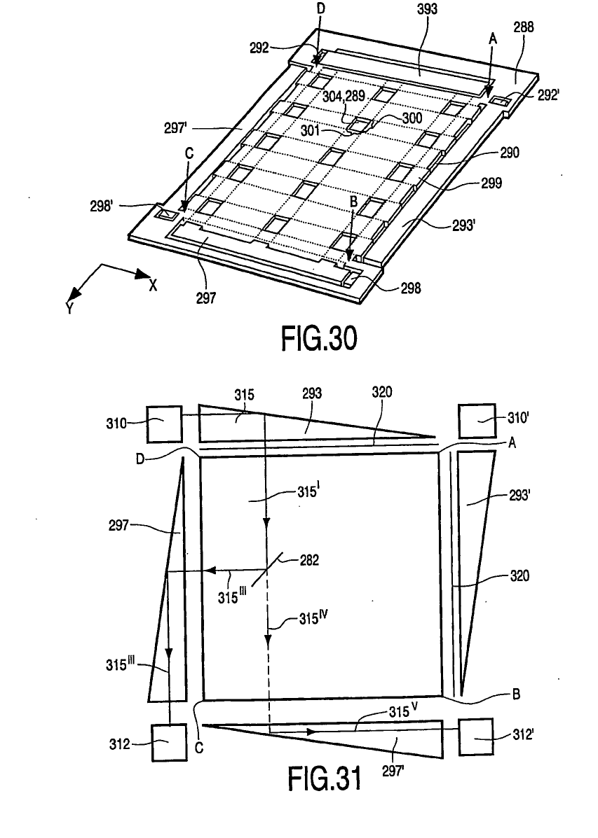

FIG. 30 is a top view of an embodiment of the light guides in this mobile phone;

FIG. 31 is a top view of another embodiment of these light guides;

FIG. 32 shows an integration of an optical input device with an optical keyboard;

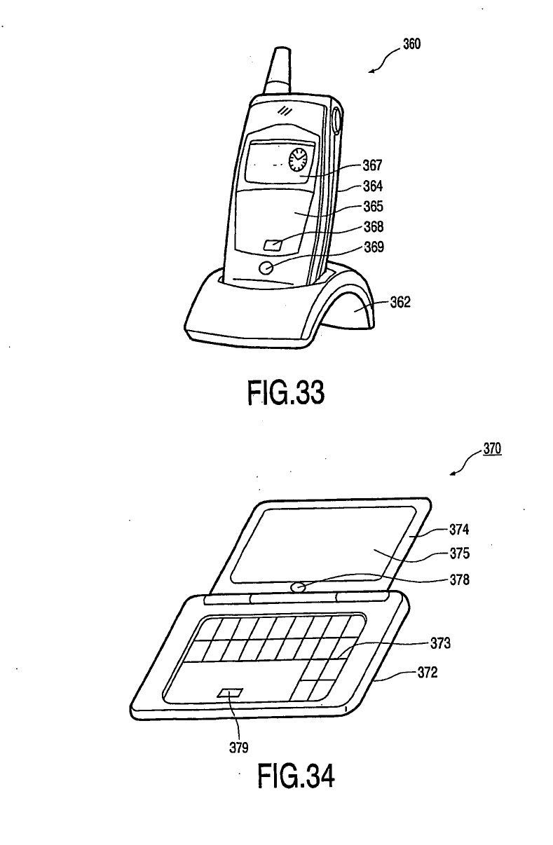

FIG. 33 shows a cordless phone wherein the invention is implemented, and

FIG. 34 shows a laptop computer wherein the invention is implemented.

FIG. 1 shows a first and important application of the new input device, namely in a mobile, or cellular, telephone apparatus 1. The front surface of this apparatus is provided with a key entry section, or keyboard, 3, which comprises a number of button switches (keys) 4 for dial entry and other functions. A display device 5 is disposed above the section 3 and an antenna 7 is provided on the top surface of the phone 1. When a dial, such as a ten-key dial, or another command is entered from the button switches 4, information relating to the entered command is transmitted via a transmitting circuit, not shown, accommodated in the phone and the antenna to a base station of a telephone company. Other commands entered via the button switches may be processed in the phone circuitry to activate different functions built in the phone circuitry, such as selecting a given phone number of a stored list or sending a given message from a table of standard messages. By providing the phone apparatus with an input device 10 and additional circuitry to control the movement of a cursor 8 across the display device 5, some of the existing functions can be performed in an easier way and new functions can be created. The input device 10, only the window of which is shown in FIG. 1, may be arranged at several positions on the phone, for example below the button switches, as shown in FIG. 1, or on one of the side surfaces. Preferably, the window of the input device is located at one of the positions where the fingers are usually placed to hold the phone apparatus. The circuitry of the apparatus is able to display a menu of functions and a movement of a finger across the input window of the input device 10 can move the cursor 8 to a given function. Moving the finger in a direction perpendicular to the window can activate this function.

The input device 10 can provide great advantages when integrated in a mobile phone provided with a standard protocol, such as the WAP protocol or the I-mode Internet protocol. By means of such a protocol, the apparatus can be used as a terminal for a worldwide communication network, such as the Internet. As this becomes more and more widely spread, there is a need for new end user apparatus. First candidates are mobile phones and TV sets equipped with a set-top box. For the new purpose, these apparatus should be equipped with a small input device that fits in well, for example the mobile phone or the TV remote control.

It should be noted that, for the newer application, the display device 5 is usually larger relative to the keyboard 3 than is shown in FIG. 1. This means that the room available in the keyboard for integration of an optical input device is limited and that this device should be small. Newer types of mobile phones, which comprise two portions and which can be folded out for use, allow use of a large display. Such a mobile phone is diagrammatically shown in FIG. 2.

The optical input device may be a device of the type described in EP-A 0 924 285. FIG. 3, which is reproduced from EP-A 0924 285, shows the input device for measuring the translation of a surface 12, which may be a finger surface. The device comprises a diode laser 14 for supplying a measuring beam 15, which is incident on the surface 12. A partially transmitting diffraction grating 16 is arranged close to the surface 12. Light, which is reflected from this grating and light reflected from the surface 12 are both incident on a radiation-sensitive detector 22, after passage through a spatial filter. This filter is composed of a lens 18 and a pinhole 20. The interfering lights on the detector generate a beat signal, i.e. a surface translating dependent oscillating signal. The beam of radiation reflected by the grating and captured by the detector 22 is used as a local oscillator beam. Preferably, this beam comprises radiation that is reflected in the zero order by the grating. The grating also produces plus and minus first-order beams 19 and 21, which may also be used. The reference numeral 17 in FIG. 3 denotes light that is scattered by the surface 12. For details about this device and embodiments thereof, reference is made to EP-A 0 942 285.

Preferably, use is made of an input device, which has recently been developed in the laboratory of the inventors. This device, which is based on another detection concept, is easier to manufacture and has more capabilities.

FIG. 4a is a diagrammatic cross-section of this input device 30. The device comprises at its lower side a base plate 31, which is a carrier for the diode lasers, in this embodiment lasers of the type VCSEL, and the detectors, for example photodiodes. In FIG. 4a only one diode laser 33 and its associated photodiode 34 is visible, but at least a second diode laser 35 and associated detector 36 may be provided on the base plate, as shown in the FIG. 4b top view of the device. The diode lasers 33 and 35 emit laser, or measuring, beams 43 and 47, respectively. At its upper side, the device is provided with a transparent window 42 across which a human finger 45 is to be moved. A lens 40, for example a plane-convex lens is arranged between the diode lasers and the window. This lens focuses the laser beams 43 and 47 at or near the upper side of the transparent window. If an object, like the finger 45, is present at this position, it scatters the beam 43. A part of the radiation of beam 43 is scattered in the direction of the illumination beam 43 and this part is converged by the lens 40 on the emitting surface of the diode laser 43 and re-enters the cavity of this laser. As will be explained hereinafter, the radiation returning in the cavity induces changes in this cavity, which results in, inter alia, a change of the intensity of the laser radiation emitted by the diode laser. This is called the self-mixing effect In the original version of the device the intensity change due to the self-mixing effect can be detected by the photodiode 44, which converts the radiation variation into an electric signal. This signal is processed in an electronic circuitry 48. The circuitries 18 and 19, shown in FIGS. 4a and 4b, for the signal of the photodiodes 34 and 36, respectively, have only an illustrative purpose and may be more or less conventional. As is illustrated in FIG. 4b, these circuitries may be interconnected.

FIG. 5 illustrates the principle of the input device and the method of measuring when a horizontal emitting diode laser and a monitor photodiode arranged at the rear facet of the laser are used. In this Figure, the diode laser, for example diode laser 33 is schematically represented by its cavity 50 and its front and rear facets, or laser mirrors, 51 and 52, respectively. The cavity has a length L. The object or finger, whose movement is to be measured, is denoted by reference numeral 45. The space between this object and the front facet 21 forms an external cavity, which has a length L₀. The laser beam emitted through the front facet is denoted by reference numeral 55 and the radiation reflected by the object in the direction of the front facet is denoted by reference numeral 56: Part of the radiation generated in the laser cavity passes through the rear facet and is captured by the photodiode 34.

If the object 45 moves in the direction of the illumination beam 43, the reflected radiation 56 undergoes a Doppler shift. This means that the frequency of this radiation changes or that a frequency shift occurs. This frequency shift is dependent on the velocity with which the object moves and is of the order of a few kHz to MHz. The frequency-shifted radiation re-entering the laser cavity interferes with the optical wave, or radiation generated in this cavity, i.e. a self-mixing effect occurs in the cavity. Dependent on the amount of phase shift between the optical wave and the radiation re-entering the cavity, this interference will be constructive or negative, i.e. the intensity of the laser radiation is increased or decreased periodically. The frequency of the laser radiation modulation generated in this way is exactly equal to the difference between the frequency of the optical wave in the cavity and that of Doppler-shifted radiation re-entering the cavity. The frequency difference is of the order of a few kHz to MHz and is thus easy to detect. The combination of the self-mixing effect and the Doppler shift causes a variation in the behavior of the laser cavity; especially its gain, or light amplification, varies.

This is illustrated in FIG. 6. In this Figure, curves 61 and 62 represent the variation of the frequency ν of the emitted laser radiation and the variation of the gain g of the diode laser, respectively, as a function of the distance L₀ between the object 15 and the front mirror 21. Both ν, g and L₀ are in arbitrary units. As the variation of the distance L₀ is the result of movement of the object, the abscissa of FIG. 6 can be re-scaled in a time axis, so that the gain will be plotted as a function of time. The gain variation Δg as a function of the velocity ν of the object is given by the following equation:

$$Δ g = - \frac{K}{L} \cdot cos \cdot \frac{\{ 4 π υ \cdot v \cdot t}{c} + \frac{4 π \cdot {L}_{0} \cdot t \}}{c}$$

In this equation:
K is the coupling coefficient to the external cavity; it is indicative of the quantity of radiation coupled out of the laser cavity;
ν is the frequency of the laser radiation;
v is the velocity of the object in the direction of the illumination beam
t is the moment of time, and
c is the light velocity.

The equation can be derived from the theory based on the self-mixing effect disclosed in the article: “Small laser Doppler velocimeter based on the self-mixing effect in a diode laser” in Applied Optics, Vol. 27, No. 2, 15 Jan. 1988, pages 379-385, and in the article: “Laser Doppler velocimeter based on the self-mixing effect in a fiber-coupled semiconductor laser: theory” in Applied Optics, Vol. 31. No. 8, 20 Jun. 1992, pages 3401-3408. These articles disclose the use of the self-mixing effect for measuring velocities of objects, or in general solids and fluids, but do not suggest the use of the self-mixing effect in an input device as discussed here. This use is based on the recognition that a measuring module using the self-mixing effect can be made so small and cheap that it can be installed easily and without much additional cost in existing apparatus.

The object surface 45 is moved in its own plane, as is indicated by the arrow 46 in FIG. 5. Because the Doppler shift occurs only for an object movement in the direction of the beam, this movement 46 should be such that it has a component 46′ in this direction. It becomes thereby possible to measure the movement in an XZ plane, i.e. the plane of the drawing in FIG. 5, which movement can be called the X movement. FIG. 5 shows that the object surface has a skew position with respect to the rest of the system. In practice, usually the measuring beam is a skew beam and the movement of the object surface will take place in an XY-plane. The Y-direction is perpendicular to the plane of the drawing in FIG. 5. The movement in this direction can be measured by a second measuring beam, emitted by a second diode laser, and scattered light of which is captured by a second photodiode associated with the second diode laser. A (the) skew illumination beam(s) is (are) obtained by arranging the diode laser(s) eccentrically with respect to the lens 40, as shown in FIG. 4a.

In the original version of the device determining the variation of the laser cavity gain caused by the object movement by measuring the intensity of the radiation at the rear laser facet by a monitor diode is the simplest, and thus the most attractive way. Conventionally, this diode is used for keeping the intensity of the laser radiation constant, but now it is also used for measuring the movement of the object.

Another method of measuring the gain variation, and thus the movement of the object, makes use of the fact that the intensity of the laser radiation is proportional to the number of electrons in the conduction band in the junction of the laser. This number is in turn inversely proportional to the resistance of the junction. By measuring this resistance, the movement of the object can be determined. An embodiment of this measuring method is illustrated in FIG. 7. In this Figure, the active layer of the diode laser is denoted by reference numeral 65 and the current source for supplying this laser is denoted by reference numeral 66. The voltage across the diode laser is supplied to an electronic circuit 70 via a capacitor 68. This voltage, which is normalized with the current through the laser, is proportional to the resistance, or impedance, of the laser cavity. The inductance 67 in series with the diode laser forms a high impedance for the signal across the diode laser.

Besides the amount of movement, i.e. the distance across which the object or finger is moved and which can be measured by integrating the measured velocity with respect to time, also the direction of movement has to be detected. This means that it has to be determined whether the object moves forward or backward along an axis of movement. The direction of movement can be detected by determining the shape of the signal resulting from the self-mixing effect. As shown by graph 62 in FIG. 6, this signal is an asymmetric signal.

The graph 62 represents the situation where the object 45 is moving towards the laser. The rising slope 62′ is steeper than the falling slope 62″. As described in the above-mentioned article in Applied Optics, Vol. 31, No. 8, 20 Jun. 1992, pages 3401-3408, the asymmetry is reversed for a movement of the object away from the laser, i.e. the falling slope is steeper than the rising slope. By determining the type of asymmetry of the self-mixing signal, the direction of movement of the object can be ascertained. Under certain circumstances, for example for a smaller reflection coefficient of the object or a larger distance between the object and the diode laser, it may become difficult to determine the shape or asymmetry of the self-mixing signal.

A further method of determining the direction of movement is therefore preferred. This method uses the fact that the wavelength λ of the laser radiation is dependent on the temperature of, and thus the current through, the diode laser. If, for example, the temperature of the diode laser increases, the length of the laser cavity increases and the wavelength of the radiation that is amplified increases. Graph 75 of FIG. 8 shows the temperature (T_{d}) dependency of the wavelength λ of the emitted radiation. In this Figure, both the horizontal axis, T_{d}, and the vertical axis, λ, are in arbitrary units.

If, as is shown in FIG. 9, a periodic drive current I_{d}, represented by the graph 80, is supplied to the diode laser, the temperature T_{d} of the diode laser rises and falls periodically, as shown in graph 82. This results in a standing optical wave in the laser cavity which has a periodically varying frequency and thus a continuously varying phase shift with respect to the radiation reflected by the object and re-entering the cavity with a certain time delay. In every half period of the drive current, there are now successive time segments wherein the diode laser gain is higher and lower, depending on the phase relation of the wave in the cavity and the reflected radiation reentering the cavity. This results in a time-dependent intensity variation (I) of the emitted radiation as shown in graph 84 of FIG. 9. This graph represents the situation for a stationary, or non-moving, object. The number of pulses in a first half period ½ p(a) is equal to the number of pulses in a second half period ½ p(b).

A movement of the object causes a Doppler shift of the radiation re-entering the laser cavity, i.e. the frequency of this radiation increases or decreases dependent on the direction of movement. A movement of the object in one direction, the forward direction, causes a decrease of the wavelength of the re-entering radiation, and a movement in the opposite direction causes an increase of the wavelength of this radiation. The effect of the periodic frequency modulation of the optical wave in the laser cavity is that, in case the Doppler shift has the same sign as the frequency modulation in the laser cavity, the effect of Doppler-shifted radiation re-entering the cavity is different from the effect this radiation has in case said frequency modulation and Doppler shift have opposite signs. If the two frequency shifts have the same sign, the phase difference between the wave and the re-entering radiation changes at a slow rate, and the frequency of the resulting modulation of the laser radiation is lower. If the two frequency shifts have opposite signs, the phase difference between the wave and the radiation changes at a faster rate, and the frequency of the resulting modulation of the laser radiation is higher. During a first half period ½ p(a) of the driving laser current, the wavelength of the generated laser radiation increases. In the case of a backward moving object, the wavelength of the re-entering radiation also increases, so that the difference between the frequencies of the wave in the cavity and that of the radiation re-entering this cavity is lower. Thus, the number of time segments during which the wavelength of re-entering radiation is adapted to the wavelength of the generated radiation is smaller than in the case of absence of electrical modulation of the emitted laser radiation. This means that, if the object moves in the backward direction, the number of pulses in the first half period is smaller than if no modulation were applied. In the second half period ½ p(b), wherein the laser temperature and the wavelength of the generated radiation decrease, the number of time segments wherein the wavelength of the re-entering radiation is adapted to that of the generated radiation increases. Thus, for a backwardly moving object, the number of pulses in the first half period is smaller than the number of pulses in the second half period.

This is illustrated in graph 88 of FIG. 10, which graph shows the intensity I_{b} of the laser radiation emitted if the object moves in the backward direction. Comparing this graph with graph 84 of FIG. 9 shows that the number of pulses in the first half period has decreased and the number of pulses in the second half period has increased. If the object moves in the forward direction, whereby the wavelength of radiation scattered by the object and re-entering the laser cavity decreases due to the Doppler effect, the number of pulses in a first half period ½ p(a) is larger than the number of pulses in a second half period ½ p(b). This can be verified by comparing graph 86 of FIG. 10, representing the intensity I_{f} of the radiation emitted in the case of a forwardly moving object with graph 84 of FIG. 9.

In an electronic processing circuit, the number of photodiode signal pulses counted during the second half period ½ p(b) is subtracted from the number of pulses counted during the first half periods ½ p(a). If the resulting signal is zero, the object is stationary. If the resulting signal is positive, the object moves in the forward direction and if this signal is negative, the object moves in the backward direction. The resulting number of pulses is proportional to the velocity of the movement in the forward and backward directions, respectively.

Under certain circumstances, for example if the optical pathlength between the laser and the object is relatively small and the frequency and amplitude of the electrical modulation are relatively small, whereas the movement to be detected is relatively fast, it may occur that the number of pulses generated by the Doppler effect is higher than the number of pulses generated by the electrical modulation. In such situations, the direction of movement can still be detected by comparing the number of pulses during a first half period with the number of pulses during a second half period. However, the velocity is then not proportional to the difference of these two numbers. In order to determine the velocity in such situations, said two numbers should be averaged and a constant value should be subtracted from the result. The number obtained in this way is a measure of the velocity. A person skilled in the art can easily design an electronic circuit for carrying out this calculation.

Instead of the triangularly shaped drive current Id used in the embodiment described with reference to FIGS. 9 and 10, also a drive current of a different shape, such as a rectangular shape, may be used.

The method of measuring the velocity and the direction of the object movement described above can also be used if the gain variation is determined by measuring the variation of the resistance of the diode laser cavity.

The measuring method requires only a small Doppler shift, for example in terms of wavelength, a shift of the order of 1.5.10⁻¹⁶ m, which corresponds to a Doppler frequency shift of the order of 100 kHz for a laser wavelength of 680 nm.

Object movements along two perpendicular (X and Y) directions, or measuring axes, in one plane can be measured with the input device of FIG. 4, which device comprises two diode lasers and associated photodiodes in a perpendicular orientation. Adding a third diode laser and an associated photodiode to the device enables this device to measure also the movement along a third, Z-, direction, or measuring axis. The third diode laser may be arranged on the optical axis of the lens 40 so that the third illumination beam is perpendicularly incident on the window finger 42 and the object, or finger, 45 and has no components in the other directions. An optimum measuring signal for the Z direction may then be obtained. In order to increase the reliability and accuracy of the X and Y measuring signals, three diode lasers may be arranged on one circle and at a mutual angular distance of 120°. This configuration is shown in FIG. 11 wherein the third diode laser and third photodiode are denoted by the reference numerals 37 and 38, respectively. When the output signals of the photodiodes 34, 36 and 38, or the resistance measuring signals, are represented by S₃₄, S₃₆ and S₃₈, respectively, the object velocities Vₓ, V_{y} and V_{z} along the X, Y and Z measuring axes, respectively, can be calculated, for example, as follows:
Vₓ=2.S₃₄−S₃₆−S₃₈
V_{y}=√3.(S₃₈−S₃₆)
V_{z}=1/√2.(S₃₄+S₃₆+S₃₈)

The electronic circuit for performing this calculation comprises summing and subtracting elements and is relatively easy to implement.

The values of the velocities and, by integration with respect to time duration of movement, the distance of the movement in the X and Y directions obtained in this way are more reliable and accurate, because they are the result of averaging the output signals of at least two photodiodes. Movement errors, or unwanted movements, such as slightly lifting the finger, have a similar effect on the output signals of the photodiodes. As the movements along the X and Y measuring axes are determined by subtracting output signals from each other, the influence of an unwanted movement on the X and Y-measuring signals is eliminated. Only the Z-measuring signal, V_{z}, which is obtained by adding the output signals of the three photodiodes, is indicative of an up/down movement of the finger, or another object.

In applications wherein the movement of a human finger in the Z direction and the input device relative to each other is used to perform a click function, it suffices to detect that such a movement takes place. An accurate measuring of the displacement of the object is not necessary so that the Z-measurement may be rather rough. Even the direction of the movement need not be detected.

Hardly any requirements have to be set to the structure or reflection coefficient of the finger. It has been demonstrated that also movement of a piece of blank paper relative to the input device can easily be measured so that input to the device can also be given by an object other than a finger.

From an optical point of view, the dimensions of the optical input device may be very small. Window 42 may have a diameter of a few mm or a size of a few mm squared. The electronics of the device need not be arranged close to the optics so that the electronics can be arranged at locations in the apparatus where some space is available. Because of the measuring principle used in this device, its components need not be aligned accurately, which is a great advantage for mass production.

In the input device shown in FIG. 11, the measuring beams are not focused in the plane of the window. As, moreover, these beams originate from different positions at the base plate level, the illumination beams form illumination spots at different positions in the action plane, for example the plane of the window. The illumination beams and their scattered radiation are sufficiently spatially separated, so that the crosstalk between the different measuring axes does not usually cause a problem. If necessary, residual crosstalk can be reduced by using diode lasers with slightly different wavelengths. For this purpose, a wavelength difference of a few run is already sufficient.

Another possibility of eliminating crosstalk is the use of a control drive for the diode lasers, which causes only one laser to be activated at any moment. A multiplexing driving circuit, which circuit alternately activates the different diode lasers, may constitute such a control drive. Such a multiplexing circuit allows monitoring of two or three diode lasers by means of one detector, or photodiode, which is arranged within reach of the radiation from each diode laser, and is used in a time-sharing mode. An additional advantage of the embodiment with such a driving circuit is that the space needed for the circuitry and the electric power consumption of the device is reduced.

Instead of using a lens 40 and folding mirrors, in case horizontally emitting diode lasers are used, the laser beams may also be guided to the window 42 by means of optical fibers. FIGS. 12a and 12b show an arbitrary embodiment of the input device provided with such fibers. FIG. 12a is a vertical cross-section and FIG. 12b is a top view of this embodiment. The input ends of the fibers 92, 93 and 94 are optically coupled to the diode lasers 33,35 and 37, respectively, in a well-known way. All output ends of the fibers are located at the window of the device. The fibers may be embedded in a cap 96 of solid material, for example, epoxy or another transparent or non-transparent material. Each of these fibers forms an isolator for the radiation guided by this fiber, both for the illumination radiation from the associated diode laser and the scattered radiation returning to this laser. Consequently, crosstalk between the different measuring axes is very small or absent. When the fibers are not embedded, use can be made of their flexible nature, which increases the possibility of designing the input device in an apparatus. Moreover, fibers can transport the radiation over arbitrary distances so that the diode lasers and photodiodes can be arranged at quite remote distances from the window of the input device. In the embodiment of FIGS. 12a and 12b, the diode lasers and associated photodiodes are arranged close together and these elements may be arranged in a separate compartment 97, as shown in FIG. 12a. The diode lasers, on the one hand, and the photodiodes, on the other hand, may also be located at a larger distance and may be optically connected via a transparent medium or by fibers.

In case the input device has to measure only X and Y-movements and a Z-measurement, for example for a click function, is not needed, it can operate with two diode lasers instead of three diode lasers shown in FIG. 11.

However, by properly arranging the diode lasers, and thus the measuring beams, relative to the window and properly processing the signals of the photodiodes, it becomes possible to measure in the X, Y and Z-directions by means of an input device having only two diode lasers. Such an input device can be used in an up-down scroller for scrolling menu charts and has the capability to determine a click, which activates a menu, which is pointed at by a cursor controlled by the up-down switch. Such an input device, which may be called optical scroll switch, can be easily built of discrete components, which allows fast new developments.

FIG. 13 shows a first embodiment of the optical scroll switch 100. It comprises two laser/diode units 101, 102, which in the original version each comprise a diode laser and a photodiode. In the new apparatus, separate diode lasers and photodiodes are used instead of such a unit. In the path of each beam 105, 106 emitted by the diode lasers 101 and 103, respectively, a lens 103, 104 is arranged which focuses the associated beam in an action plane 107, which may be the plane of the device window. This window 112 may form part of the housing 109 of the apparatus in which the device is incorporated, for example a mobile phone as shown in a side view in FIG. 14. The diode lasers and the associated lenses are arranged in such a way that the chief rays of the beams 105 and 106 are at opposite angles with respect to the normal to the window 112, for example at angles of +45′ and −45°, respectively.

The object or human finger 108 is moved across the action plane for a scrolling action and moved perpendicularly to this plane for a clicking action. As described hereinbefore, both actions cause a Doppler shift in the radiation reflected by the finger towards the diode lasers 101 and 102. The output signals of the detectors associated with these diode lasers are supplied to signal processing and laser drive electronic circuitry 110. This circuitry evaluates the movements of, for example the controlling finger 108 and supplies information about said movements at its output 111.

The laser/diode units 101 and 102, the lenses 103 and 104, the window 112 and the electronic circuitry 110 and software may be integrated in one module. This module is placed as such in the mobile phone or in another apparatus, which should be provided with a scrolling and clicking function. It is also possible to implement the input device with discrete elements. Especially part of the signal processing may be carried out by a microcontroller or other controlling means which forms part of the mobile phone or other apparatus, such as a remote control, a cordless phone or a portable computer.

As described hereinbefore, a movement of a finger or other object towards and/or away from the laser/diode units may be detected by modulating the laser currents and counting the pulses received by the detectors. From the output signals Sign₁ and Sign₂ of these detectors, which represent velocities of the object along the chief rays of the beams 105 and 106, respectively, the velocity (V_{scroll}) parallel to the window and the velocity (V_{click}) perpendicular to the window can be calculated as follows:
V_{scroll}=½ √2.(Sign₁−Sign₂)
V_{click}=½ √2.(Sign₁+Sign₂)

FIG. 15 shows a second embodiment of an optical scroll switch 120. This embodiment differs from that of FIGS. 13 and 14 in that the two lenses 103 and 104 and the window 112 have been replaced by a single component 122. This element focuses both beams 105 and 106 on its upper surface 124, which forms the device window.

If the input device of FIGS. 13 to 15 needs to provide only a scrolling function, only one diode laser, lens and detector is required in principle.

An apparatus, like a mobile phone, wherein the input device, for example the optical scroll switch, is integrated usually comprises a display, for example a liquid crystal display panel. FIG. 16 is a diagram of a conventional transmission liquid crystal panel 130. This panel comprises a layer 132 of liquid crystalline material, for example of the nematic type, which is enclosed between two transparent plates 134 and 135, for example of glass. Drive electrodes 136 and 137 are arranged on each plate. At least the electrode 137 is divided into a large number of rows and columns so that a large number of picture elements, or pixels, in the display panel is defined. The different pixels are controlled by driving the matrix electrodes, as is shown schematically by means of the drive terminals 138 and 139. Thus, an electric field can be applied across the liquid crystalline material 132 at the required positions, i.e. the pixel positions. Such an electric field causes a change of the effective refractive index of the material 132, i.e. a change in the alignment and light polarization properties of its elongated molecules. The light passing through a pixel undergoes, or does not undergo, a rotation of the polarization depending on the absence, or presence, of a local electric field at the location of the relevant pixel. By means of a polarizing filter 141 arranged between the electrode 136 and the viewer's eyes, the polarization change is converted into an intensity change so that the pixel becomes visible or non-visible to the viewer. The totality of visible and non-visible pixels forms an image, which can be changed rapidly, for example 25 or 50 times a second. A display panel wherein the pixels are formed by the intersection of, and are directly controlled by the voltage between the row and column electrodes is termed a passive-matrix display.

In stead of a passive-matrix display, an active-matrix display may be used. In this display panel, the control electronics is constituted by an array of transistors, which are arranged on the plate 135. Each pixel is now controlled by its own transistor, preferably a thin-film transistor (TFT). Both types of displays are described in, for example, EP-A 0 266 184. Active matrix displays are able to show color images of superb quality and high resolution and are developing to devices, which can show more and more complex information. Passive-matrix displays are easier to manufacture and consume relatively low power. These displays are suitable for applications where the demands with respect to brightness, number of pixels and response time are moderate.

LCD panels are not emissive, i.e. they do not generate light. Instead, direct-view transmission LCD panels are provided with backlighting means. FIG. 17 shows an embodiment of the backlighting means 143. This means comprises a transparent light guiding plate 1, comprising a light source and a planar light guide 145, for example of glass or transparent plastics. FIG. 17 shows only a portion of this plate. The plate 145 has an upper main flat surface 147, facing the liquid crystalline layer 132 (not shown in FIG. 17), a lower main flat surface 148 and four side surfaces, only one of which, 15, is shown in FIG. 17. Usually at least one light source 152, arranged in a parabolic reflector 160, is arranged opposite at least one of the side surfaces 150. The plate 145 is provided with a number of light-scattering elements 154. Light rays 156 from the source 152 enters the plate 145 via the side surface 150 and are totally internally reflected one, two or more times, dependent on the direction of the light ray, before they reach a scattering element 154. Such an element reflects light incident thereon in different directions. A portion of the reflected light, denoted by the rays 158, has such a direction that it passes through the upper surface 147 of the plate and propagates to the liquid crystal layer 132. The rest of the reflected light further propagates in the plate 145 until it reaches a further scattering element 155. A portion of the light reflected by this element and denoted by the rays 159 passes through the upper surface 147 of the plate 145 and the rest further propagates in the plate. This goes on until substantially all the light that entered the plate via the side surface 150 is coupled out of the plate and is directed towards the liquid crystal layer 132.

For the envisaged application a reflective display panel is preferably used. FIG. 18 is a diagram of an embodiment of a reflective LCD panel 170. This panel comprises a liquid crystal layer 172, similar to the layer 132 in FIG. 16. The layer 172 is sandwiched between a transparent plate 174, similar to the plate 134 in FIG. 16 and a second plate 175. The plate 174 is provided with one counter electrode and the plate 175 carries an array of controlling transistors, one for each pixel, which controlling array is schematically denoted by a layer 177. The front side 179 of the plate 175 is reflective. The reflective panel 170 functions in the same way as the transmission panel 130 of FIG. 16, with the exception that the image forming light is reflected and not transmitted.

As the controlling transistors in a reflective panel are arranged under the liquid crystal layer 172 and thus do not cover portions of this layer, substantially the whole surface area of the liquid crystal layer can be occupied by effective, i.e. blank, areas of the pixels. This means that a reflective panel has a larger resolution than a transmissive panel. Moreover, substantially all light incident on the panel is reflected and modulated and used for display of the images. A reflective display panel makes much more efficient use of the available light than a transmissive panel. Furthermore, a reflective display panel may use ambient light, so that no additional lighting of the panel is needed when it is used in a bright or daylight environment. The contrast in the displayed image increases with an increasing intensity of the ambient light, because the intensity of the image forming reflected light also increases, whilst the degree of blackness of the black pixels does not change. When a transmissive display panel is used in an environment with increasing ambient light, the contrast of the displayed image will decrease. It will be clear from the above that, in general, a reflective display panel requires considerably less power from the battery, which supplies electrical power to the illumination means.

This illumination means is a front-lighting means, instead of a backlighting means. An embodiment of a front-lighting means is shown in FIG. 19. The scattering elements 154′ and 155′ are now arranged at the upper side 147′ of the light guide plate 145′ so that the light is now emitted through the lower side 148′ of the plate. With the exception of the direction of the emitted light, the front-lighting means of FIG. 19 have the same elements and operate in the same way as the backlighting means of FIG. 17. FIG. 19 thus needs no further explanation.

Especially for a mobile phone it is attractive to carry out a further integration, namely to combine the display panel with a solid state camera so that an image-sensing display device is obtained. A reflective image-sensing display device is disclosed in WO 02/11406. Two embodiments of this device are shown very schematically in FIGS. 20a and 20b. In these Figures, reference numeral 150′ denotes the front lighting means and reference numeral 170 denotes the reflective display panel, which has a front glass 184. Reference numeral 182 denotes the image sensor, for example a CCD sensor. In the embodiment of FIG. 20a, the image-sensing array is arranged on top of the front glass 184, whilst in the embodiment of FIG. 20b this array is arranged between the front glass 184 and the display panel 170. The lens means needed for the camera function are constituted by flat diffraction lenses, such as a Fresnel lens and an array of microlenses, arranged on one or more of the surfaces in front of the image-sensing array (LCD). For a detailed description of the image-sensing display device and embodiments thereof, reference is made to WO 02/11406.

According to the invention, the radiation for the back light guide or the front light guide is supplied by the diode laser(s) of the optical input device present in the same apparatus. This is schematically shown in FIG. 21 for the case where the display device is embedded in the same part of the apparatus as the input device. FIG. 21 shows a diode laser 202, a converging lens 204 and a window 206, which elements together constitute the optical input device. The rear side of the diode laser is arranged to a side face of a light guide 200, which is shown in a cross-sectional view. The light guide 200 is similar to the light guide 145 of FIG. 17, in the case of a transmissive panel, or similar to the light guide 145′ of FIG. 19, in the case of a reflective panel. Laser radiation emitted by the laser rear side propagates through the light guide so that the rear side of the diode laser constitutes the radiation source of the illumination means for the display panel. If necessary, a diverging lens 208 can be used to ensure that the light rays emitted by the rear side of the laser have the required angles of incidence on the main faces of the light guide.

As the rear side of the diode laser is no longer available for measuring the intensity of the light generated by the laser and for measuring the self-mixing signal, a detector, for example a photodiode should be arranged at the front side of the diode laser. FIG. 21 shows such a photodiode 216, which is arranged in such a way that it receives a sub-beam 212, which is split off from the measuring beam 210 by means of a partially reflecting mirror 214. It is also possible to measure the intensity and the self-mixing signal by using radiation reflected by a surface of one of the optical elements of the input device, such as the surface of the lens 204, the inner surface of the window 206 or the front mirror of the diode laser. The measuring photodiode 216 is then arranged in such a way that it can receive such reflected radiation.

The laser intensity and the self-mixing signal may also be measured by determining the impedance of the laser cavity, as described with reference to FIG. 7.

Instead of arranging a laser with its own encapsulation to the light guide, as shown in FIG. 21, it is also possible to place a bare laser dice directly on the light guide material or on an intermediate layer, for example a silicon layer so that costs and space can be saved.

The window 206 of the optical input device can be embedded in a side wall 219 of the casing 218 of the mobile phone, as shown in FIG. 21. It is also possible to arrange this window in the surface of this casing accommodating the keyboard. This window is preferably a convex surface, as shown in FIG. 21. This has the advantage that the window cannot gather dirt and grease and that it can easily be detected by a human finger.

If the optical input device is embedded in a first portion of the mobile phone wherein also the keyboard is accommodated whilst the display device is arranged in a second portion, as shown in FIG. 2, the radiation from the rear side of the diode laser can be transported to the lighting means of the display device by means of an optical fiber. This fiber can be guided through the hinge 9, shown in FIG. 2, which connects the two portions 2 and 6 of the mobile phone.

If optical input device comprises a second and a third diode laser, the backward emitted laser beam of either the second diode laser or both the second and third diode laser may be used to illuminate the light guide of the display device. If, in addition to the display device, the mobile phone comprises a second and a third optical device, these devices may be supplied with the backwardly emitted laser beam of the second and third diode laser, respectively, if present. If the input device comprises only a first and a second diode laser, whilst the apparatus comprises three optical devices, the laser beam of a first diode laser may be supplied to a first optical device and the laser beam of a second diode laser may be supplied to both the second and the third optical device. If the input device comprises only one diode laser and the apparatus has more than one other optical device, the backwardly emitted radiation from this diode laser can be distributed on the other optical devices. The distribution ratio for the other optical devices is determined by the amount of radiation required for each of these devices.

Dependent on the number of diode lasers within the optical input device and the number and type of other input devices, several embodiments of the laser radiation distribution are possible.

FIG. 22 shows a first embodiment wherein the optical input device 220 comprises only one diode laser 222 and the apparatus comprises two other optical devices 230 and 240. The backwardly emitted laser beam 224 from the diode laser is divided into two beams 225 and 226 by means of a beam splitter, for example a semi transparent mirror or, generally, a partially transmitting mirror 223. The beams 225 and 226 are guided to the optical devices 230 and 240, respectively, for example by means of optical fibers 227 and 228. In this and the following Figures, reference numerals 229 and 221 denote the lens and the window, respectively, of the input device.

FIG. 23 shows the situation in which the input device comprises only one diode laser and the apparatus comprises three other optical devices. The backwardly emitted beam 254 from the diode laser 222 is divided into three beams 254, 255 and 256 by means of two beam splitters 251, and 252. These beams may be guided to the respective other optical devices 230, 240 and 250 by optical fibers 258, 259 and 260, respectively. The division ratio of the beam splitters, i.e. their transmission reflection ratio is determined by the amount of radiation required for each of the different types of devices 230, 240 and 250.

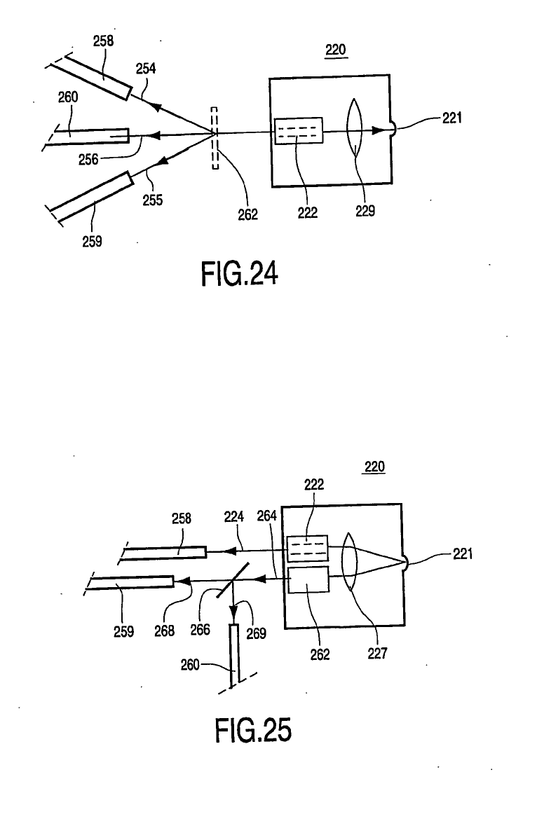

The beam splitters 251 and 252 may also be replaced by one grating 262, as shown in FIG. 24. This grating is designed in such a way that the incident radiation is diffracted in a, non-deflected, zero-order beam 256 and a plus and minus first-order beam 25, respectively, which are deflected in opposite directions. The required radiation distribution on the three beams can be achieved by a proper choice of the grating parameters, like the depth of the grating grooves and the ratio of the groove width and the grating pitch. The beams can be guided to the respective other optical devices in the same way as described with reference to FIGS. 22 and 23, for example by means of light guides or optical fibers. This holds also for the following embodiments wherein, only fibers are shown by way of example.

FIG. 25 shows an embodiment of the apparatus having three other optical devices and wherein the input device has two diode lasers 222 and 224. The backwardly emitted beam 224 from diode laser 222 is supplied to fiber 258, whilst the beam 264 from diode laser 262 is divided, for example by means of a beam splitter 266, into two beams 268 and 269, which are supplied to optical fibers 259 and 260.

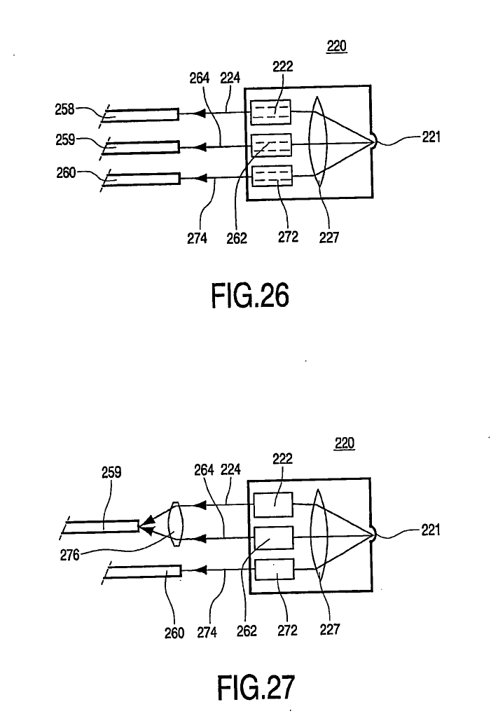

FIG. 26 shows an embodiment of the apparatus having also three other optical apparatus, but also three diode lasers 222, 262 and 272. The beams 224, 264 and 274, respectively of these diode lasers may be supplied to a different one of the other optical devices, for example by means of the fibers 258, 259 and 260, respectively. If one of the optical devices requires substantially more radiation than the other devices, the beams from two diode lasers may be supplied to this device and the beam from the other diode lasers may be divided into two beams for the other optical devices.

FIG. 27 shows an embodiment of the apparatus comprising an input device having three diode lasers and comprising two other optical devices. The beams 224 and 264 from the diode lasers 222 and 262 may now be combined, for example by means of a lens 276, and sent, via a fiber 259, to that one of the other optical devices that requires most radiation. The beam 274 of the diode laser 272 is sent to the other one of the other optical devices.

The other optical apparatus mentioned hereinbefore may also be, for example, an optical keyboard, a lighting for a keyboard in general and an optical microphone.

FIG. 28 is a front view of an embodiment of a mobile phone 280, which is provided with an optical keyboard. In this Figure, numerals 282 denote the keys of the board and reference numeral 283 denotes the display device. Also shown is a microphone 284, which is embedded in the housing 285 of the phone.

FIG. 29 is a cross-section, taken on the line II-II″ in FIG. 28, of the mobile phone. The display 283 may be a liquid crystal display comprising a layer of liquid crystal material (not shown) arranged between two substrates 286, 287. In this embodiment, the display is positioned on a transparent carrier (substrate) 288, which is provided with recesses at the positions of the keys 282.

The substrate 288 is made, for example, of transparent plastics and comprises a light guide portion and spaces for at least one light source and detector. In FIG. 30 the light guide portion 290 of the keyboard (hereinafter keyboard light guide) is situated within the rectangle ABCD. A further light guide 293 is arranged at side AD of the keyboard light guide. This light guide (hereinafter source light guide) receives radiation from a source, for example a LED, which is arranged at position 292 in the substrate. A similar source light guide 213′ may be arranged at the side AB of the keyboard light guide to receive radiation from a second light source, which is arranged at position 12′ in the substrate.

The keyboard light guide 290 is provided, for example with protruding elements, such that light from the source light guides is coupled into the keyboard only at positions of light paths 300 in the X direction and light paths 301 in the Y direction. At positions 304, where light paths 300 cross light paths 301, a recess is present, as already shown in FIG. 29.

A further light guide 297 is arranged along side BC of the keyboard light guide 390. This light guide (hereinafter detector light guide) receives radiation from the keyboard light and transports this radiation to an optical detector, for example a photodiode, arranged at position 298 in the substrate 288. A similar detector light guide 297′ may be arranged at the side CD of the keyboard light guide 290 to transport radiation from the latter guide to an optical detector arranged at position 298′ in the substrate. To improve coupling of radiation from the keyboard light guide into the detector light guides, the latter may be provided with protruding elements.

When a key 282 is pushed, it moves into the keyboard light guide and into the light paths crossing at the key position 289. Such a key will, partially or totally, reflect light travelling along these paths. As a consequence, the amount of radiation received by the optical detectors at positions 298 and 298′ will change so that the output signals of these detectors will change. As the source light guides are illuminated from one side by their associated light sources, the intensity of the radiation coupled into the keyboard light guide decreases with increasing distance of the light paths 300, 301 from the positions 292, 292′, respectively, of the light sources. Thus, the change in amplitude of the detector output signal caused by pushing a particular key depends on the distance of this key from the light source.

The output signals of the detectors, or photodiodes, are supplied to electronic detection circuits for detecting, if necessary after amplification, the changes in these signals for both the light paths 300 and light paths 301, thus providing the possibility of determining which key of the board has been pushed.

The key portions that are pushed into the keyboard light guide may be provided with a reflective material to improve their capability to reflect the radiation.

The light sources (LEDs) may be pulsed sources.

Instead of by means of photodiodes at positions 299 and 298′, the radiation from the keyboard light guide, which is to be measured, can also be guided to other positions, for example by means of reflectors or other optical components. For example, if the display 283 is controlled by a matrix of thin-film transistors, this matrix may be enlarged with additional transistors for measuring radiation from the keyboard. This option is attractive when substrate 288 is used as display substrate instead of substrate 286 in FIG. 29. If necessary, the design of the additional transistors can be optimized for their special function.

To couple radiation portions emitted from the source and having different intensities into the different Y light paths 301, the source light guide 293 may show a decreasing thickness, as shown in FIG. 31. A beam portion 315 from a source (LED) 310 is reflected as beam 315′ into a Y light path 301 by the skew upper side of the source light guide 293 towards a key in that light path. When the key is pushed down, its reflecting portion partially reflects the radiation as beam 325¹¹ towards the detector light guide 297. The skew left side of this light guide reflects the radiation as beam 315¹¹¹ towards the detector 312. To improve the reliability of the measurement, also the radiation passed by the key reflective portion, as beam 315^{1V}, can be measured. This beam is reflected by the skew surface of the second detector light guide 297′ towards the second detector 312′. In the same way, the pushed down situation of the key can be detected via the X light path by means of the radiation source 310′, the source light guide 293′, the detector light guide 297′ and the detector 312′. For this kind of detection, the light sources 312,312′should be switched on and off alternately.

It is not necessary to detect the position of the key continuously, and it suffices to perform such a detection a number of times per second.

The radiation beams sent along the different X and Y light paths 300 and 301 an be distinguished not only by different intensities, but also by different frequencies. This can be realized by arranging a color filter 320 between the source light guide 293, 293′ and the keyboard light guide 290. This filter shows a varying color over its lengths, for example, from (infra)red to (ultra)violet. In the detector branch(es), a color discrimination should also be realized. There are several possibilities of setting the intensities of the radiation beams incident on the different X and Y light paths, especially by giving the reflecting surface of the source light guides a specific structure and/or shape. As these details do not relate to the present invention, they do not need to be discussed here. Moreover the invention can be used with optical keyboards of other types than the one discussed with reference to FIGS. 28, 29, 30 and 31.

FIG. 32 schematically shows how the invention can be implemented with an optical keyboard 330. The keys of this board are denoted by the reference numeral 334. The input device 220, which is represented by a block 350 comprising the diode laser(s) and the optics and by the window 352, is accommodated in the light guide 332 of the keyboard. The backwardly emitted laser beam 344 is reflected to the several columns of keys by means of the partially transmitting mirrors 335, 336 and the fully reflective mirror 337. This design allows giving different intensities to the beams 345, 346, and 347 propagating along the different light paths. After having passed the positions of the keys in their light paths, the beams are guided to a detector 342 by means of the fully reflective mirror 338 and the partially transmitting mirrors 339 and 340.

The invention can also be implemented with a lighting device for illuminating a keyboard, which may be an optical keyboard or a keyboard of a different type. Reference is made to FIG. 2, which shows a mobile phone, which is provided with such a lighting device in its upper portion 6. Only the window 360 of the lighting device is shown in FIG. 2. This device may be quite simple and comprises the window and a light guide from the rear side of a diode laser of the optical input device to the window. The window 360 may be shaped as a lens to give the emitting light a proper distribution. This window may be arranged at arbitrary positions in the upper cover of the apparatus, provided that the emitted beam illuminates the keyboard in a proper way.

The microphone 284 accommodated in the mobile phone of FIG. 28 may be an optical microphone, which is understood to mean a microphone wherein the movement of the membrane is measured by optical means. These optical means comprises a light source, which sends an optical beam to the membrane and an optical detector to receive a beam reflected by the membrane. Lenses may be arranged between the light source and the membrane and between the membrane and the detector. When activated by a human voice or another source of sound, the membrane vibrates, which causes changes in the angle at which the optical beam is reflected by the membrane. For example, a lens between the membrane and the detector may convert these changes into changes in position variations of the spot formed by the reflected beam in the plane of the detector. A position-sensitive detector converts the position variations into variations of the detector electric output signal.

According to the invention, the backwardly emitted beam of at least one of the diode lasers of the optical input device is used as an optical beam for the optical microphone. The diode laser beam may be transported to the optical microphone via a solid or flexible (fiber) light guide.

Although the invention has been described with reference to a mobile phone, it can be used in several other apparatus, especially small battery-powered apparatus comprising, in addition to an optical input device, other optical devices as mentioned hereinbefore for the mobile phone. An example of such an apparatus is a cordless phone apparatus having the same or similar functions as the mobile phone apparatus. A cordless phone apparatus 360 is shown in FIG. 33. This apparatus is composed of a base station 362, which is connected to a phone or cable network and the movable apparatus 364 which can be used within an area with a radius of, for example, less than 100 m from the base station. Apparatus 364 comprises a keyboard 365 and a display device 367. In a similar way as described for the mobile phone apparatus, the apparatus 364 can be provided with the WAP protocol or the I-mode protocol for access to the Internet, and an optical input device 368 as described above. The keyboard 365 may be an optical keyboard and the microphone 369 may be an optical microphone and at least one of the display device, the optical keyboard and the optical microphone, may be supplied with radiation from at least one diode laser of the optical input device 368. Like the mobile phone apparatus, the apparatus 364 should be small and light-weight so that implementation of the invention in the cordless phone apparatus provides the same advantages as in the mobile phone apparatus.

The invention may also be used in a portable computer, known as notebook or laptop, an embodiment 370 of which is shown in FIG. 34. The notebook comprises a base portion 372 and a cover portion 374 with a LCD display 375. The base portion accommodates the different computer modules and the keyboard 373. In this keyboard, an optical input device 377 is arranged which replaces the conventional mouse pad. The input device may be arranged at the position of the conventional mouse pad or at any other easily accessible position. The notebook may be provided with a lighting device 378 in the cover portion, of which device only the window is shown. Again, the keyboard may be an optical keyboard and at least one of the display device 375, the optical keyboard 373 and the lighting device 378 may be supplied with radiation from at least one of the diode lasers of the optical input device 377.

A hand-held computer, for example of the type known as personal digital assistant (DPA) is a smaller version of the notebook. Such a hand-held computer may also be provided with an optical input device and other optical devices mentioned with respect to the notebook computer. As, moreover, a hand-held computer should have a smaller weight and size and consumes less energy than a notebook computer, use of the invention in a hand-held computer provides even greater advantages.

The invention can also be used in small-sized game computers.

1. An apparatus comprising an optical input device controlled by a moving object and also comprising at least one further optical device to be supplied with electromagnetic radiation, characterized in that the input device comprises at least one diode laser for supplying at least one measuring beam to a window of the input device, said measuring beam measuring movement of the object with respect to the window, and in that the rear side of at least one of the diode lasers of the input device is optically coupled to at least one of the other optical devices so as to supply such a device with radiation.

2. An apparatus as claimed in claim 1, characterized in that at least one of the diode lasers of the input device is optically coupled to a light guide of an optical keyboard.

3. An apparatus as claimed in claim 1, characterized in that at least one of the diode lasers of the input device is optically coupled to a lighting means for illuminating a flat display panel.

4. An apparatus as claimed in claim 1, characterized in that at least one of the diode lasers of the input device is optically coupled to an illuminating device for illuminating a keyboard of the apparatus.

5. An apparatus as claimed in claim 1, characterized in that at least one of the diode lasers of the input device is optically coupled to an optical microphone of the apparatus.

6. An apparatus as claimed in claim 1, wherein the input device comprises a partially transmitting object arranged close to the window so as to split off a portion of the measuring beam as a reference beam, and a radiation-sensitive detection means with a small opening so as to receive the reference beam and measuring beam radiation reflected by the object.

7. An apparatus as claimed in claim 1, wherein the optical input device comprises converting means for converting measuring beam radiation reflected by the object into an electric signal, characterized in that the converting means are constituted by the combination of a laser cavity and measuring means for measuring changes in operation of the laser cavity, which changes are due to interference of reflected measuring beam radiation re-entering the laser cavity and the optical wave in this cavity and are representative of the movement of the object.

8. An apparatus as claimed in claim 7, characterized in that the measuring means are means for measuring a variation of the impedance of the laser cavity.

9. An apparatus as claimed in claim 7, characterized in that the measuring means is a radiation detector for measuring radiation emitted by the laser.

10. An apparatus as claimed in claim 9, characterized in that the radiation detector is arranged at the side of the laser cavity where the measuring beam is emitted.

11. An apparatus as claimed in claim 7, characterized in that the optical input device comprises at least two diode lasers and at least one detector for measuring a relative movement of the object and the device along a first and a second measuring axis, which axes are parallel to the illuminated surface of the object.

12. An apparatus as claimed in claim 7, characterized in that the optical input device comprises three diode lasers and at least one detector for measuring a relative movement of the object and the device along a first, a second and a third measuring axis, the first and second axes being parallel to the illuminated surface of the object and the third axis being substantially perpendicular to this surface.

13. An apparatus as claimed in claim 7, having an optical input device for determining both a scroll action and a click action, characterized in that the optical input device comprises two diode lasers and at least one detector for measuring relative movements of the object and the device along a first measuring axis parallel to the object surface and along a second measuring axis substantially perpendicular to the object surface.

14. An apparatus as claimed in claim 7, having an optical input device for determining both a scroll action and a click action, characterized in that the optical input device comprises two diode lasers and at least one detector for measuring relative movements of the object and the device along a first and a second measuring axis, which axes are at opposite angles with respect to a normal to the object surface.

15. A mobile phone comprising an apparatus as claimed in claim 1.

16. A cordless phone comprising an apparatus as claimed in claim 1.

17. A laptop computer comprising an apparatus as claimed in claim 1.

18. A hand-held computer comprising an apparatus as claimed in claim 1.
